(19) United States
(12) Patent Application Publication
(10) Pub. No.: US 2020/0126153 A1
(43) Pub. Date: Apr. 23, 2020

(54) System and Method Using Capital Pooling and Letters of Credit for Project Financing

(71) Applicant: Michael H. Burney, Tiburon, CA (US)

(72) Inventor: Michael H. Burney, Tiburon, CA (US)

(21) Appl. No.: 16/657,526

(22) Filed: Oct. 18, 2019

Related U.S. Application Data
(60) Provisional application No. 62/748,295, filed on Oct. 19, 2018.

(51) Int. Cl. G06Q 40/02; G06Q 10/06; G06Q 40/06; G06Q 30/02

(52) U.S. Cl. CPC G06Q 40/025; G06Q 30/0279; G06Q 40/06; G06Q 10/06313

(57) ABSTRACT

The present application discloses a method and system of pooling capital from multiple and diverse sources through a special purpose project entity. Utilizing the pooled capital, the project entity issues letters of credit as collateral for loans needed to implement the project. In one embodiment, the pooled capital may be held by the project entity or the bank of the project entity. The project may receive credits for the social or environmental benefits achieved through implementation of the project and trade the credits to generate revenue.

### RELATED APPLICATIONS

The present application claims priority to U.S. provisional application No. 62/748,295, titled SYSTEM AND METHOD USING CAPITAL POOLING AND LETTERS OF CREDIT FOR PROJECT FINANCING and filed on Oct. 19, 2018, the content of which is incorporated herein in its entirety.

### FIELD OF INVENTION

The present application relates generally to a novel method of financing a project, and more specifically to project financing through pooling capitals from difference sources and issuing letters of credit based on the pooled capitals as collaterals of project loans.

### BACKGROUND

It is often difficult to identify and secure capitals to finance new projects. For example, large infrastructure or environmental projects are sometimes postponed due to lack of access to capital, despite documented need for those projects or potential economic returns from those projects.

It is also difficult for new projects to obtain loans from commercial banks. New projects typically don't have accumulated assets that can be utilized as collateral for a loan from a bank or other capital source. Existing entities may have assets that are encumbered or of not enough value to be used as collateral to finance a new project. As a result, loans are often secured against future projections of cash flow or security/ownership interest in future assets of the project.

Conventional methods of capital sourcing include loans, equity sales, and grants from government agencies or funds. Capitals typically are sourced from individuals, banks, public market sources, private capital sources, non-profit entities or government sources. The present disclosure teaches innovative methods of utilizing conventional capital sources such as those listed above and/or unconventional capital sources to finance a project.

### SUMMARY OF THE INVENTION

It is an object of the present disclosure to provide a method and system of pooling capital from multiple and diverse sources through a special purpose entity, also referred to as project entity herein, that in turn issues a letter of credit to the project's bank or banks as collateral for lending loans to implement the project.

In some embodiments, a system for organizing and managing a project using a project entity comprises one or more computer servers, storage medium, and terminals. The one or more computer servers are configured to process data, for example, financial and organizational data, and/or information related to environmental, social and economic impacts of the project. The storage medium, and optionally backup storage, are configured for storing the data and information, for example, financial and organizational data and related information, of the project. In some embodiments, the terminals are configured to support hosted and integrated e-commerce related to the project. In one embodiment, the one or more computer servers are configured to generate records of pooled capitals from one or more capital sources when the capital sources join the project. The computer servers may be configured to periodically update the records for the duration of the financial commitment or the duration of the project. In one embodiment, external wealth management firms may be utilized to invest the pooled capital and the computers servers are configured to track the financial performance of these wealth management firms.

In some embodiments, the computer servers are configured to track issued letters of credit to external project banks using the pooled capital. The letters of credit are used as collateral for collateralized loans and enable a project bank to issue a collateralized loan to project implementers. The computer servers are further configured to receive, quantify and track information of social and environmental impacts achieved by the project implementers.

In some embodiments, the computer servers are configured to integrate with project servers and to track and audit environmental or social impacts achieved by the project. In one embodiment, the computer servers are configured to convert the achieved impacts into credits. The credits may be sold to third parties in the form of water, carbon, or other offsets. After the corresponding credits are sold, the computer servers are configured to “retire” the impacts sold to third parties, and track and record the monetization of the offsets. The financial gains from the offsets may be distributed to contractual beneficiaries of the offsets.

In one embodiment, the information of environmental impact is a quantified amount of carbon dioxide emission reductions that can be converted to an amount of either carbon credits or carbon offsets tracked with numerical identifiers. In another embodiment, the information of environmental impact is a quantified amount of water consumption reduction. The quantified amount of water consumption reduction can be converted into water offsets expressed in numerical identifiers.

Both carbon credits/offsets and water offsets can be traded in a market, for example, compliance, voluntary or other markets. Water offsets can also be traded for water neutrality certificates. In some embodiments, the revenue generated from the trading of the credits or offsets are allocated to the one or more project implementers or capital sources. In one embodiment, the revenue is allocated to one or more project implementers on a pro-rata basis according the social or environmental impacts achieved by each of the one or more project implementers. In another embodiment, the revenue generated from selling the credits may be distributed to one or more of the capital sources in accordance to the amount of contributed capitals.

In some embodiments, the system may be configured to collect collateral fees from a project implementer through the project bank in exchange for providing the collateral to the bank for the implementer's loan.

In some embodiments, a method of financing a project through a project entity comprises the following steps. First, pool capital from one or more sources into the project entity. Second, issue by the project entity a letter of credit to a project bank to enable the project bank to issue a collateralized loan to one or more project implementers. The letter of credit is used as collateral for the collateralized loan. Third, collect collateral fees from the project implementer through the project bank.

In one embodiment, the method further includes the step of quantifying an impact achieved by the one or more project implementers. For example, the achieved impact may be a social or environmental beneficial impact. The quantified beneficial impact is then converted into revenue. In some cases, the quantified beneficial impact is an amount of carbon dioxide or other greenhouse gas emission reduction in the form of carbon credits or carbon offsets. In some cases, the quantified beneficial impact is an amount of water consumption reduction in the form of water offsets. The method may further comprise trading the converted credits or offsets by the project entity to generate revenue.

In some embodiments, the one or more sources from which the capitals are pooled include corporations, foundations, government agencies, industry co-operatives, non-profit organizations, private individuals or other sources. The pooled capitals may be invested to generate investment returns.

In some embodiments, a non-transitory computer-readable medium storing a computer software program is disclosed. The computer software program, when executed by a computer processor, causes the computer processor to perform the following steps: (1) generating a record of contributed capitals from one or more capital sources when the one or more capital sources join the project; (2) issuing a letter of credit to the project bank based on the record of contributed capitals to enable a project bank to issue a collateralized loan to each of one or more project implementers, wherein the letter of credit is used as collateral for the collateralized loan; (3) receiving information of social or environmental impacts achieved by the one or more project implementers; (4) converting the information of social or environmental impact into credits or offsets; and (5) trading the credits or offsets for revenue or capital returns.

### BRIEF DESCRIPTION OF THE DRAWINGS

These and other features of the present disclosure will become readily apparent upon further review of the following specification and drawings. In the drawings, like reference numerals designate corresponding parts throughout the views. Moreover, components in the drawings are not necessarily drawn to scale, the emphasis instead being placed upon clearly illustrating the principles of the present disclosure.

FIG. 1 illustrates an exemplary project that requires capital financing.

FIG. 2 illustrates an embodiment of the project financing method disclosed herein.

FIG. 3 is a block diagram of an exemplary embodiment of the project financing system disclosed herein.

FIG. 4 illustrates a first embodiment of utilizing an exemplary project financing method disclosed herein to finance a large-scale project to achieve social and environmental impacts.

FIG. 5 illustrates a second embodiment of utilizing an exemplary project financing method disclosed herein to finance a large-scale project to achieve social and environmental impacts.

FIG. 6 is a flow chart illustrating an exemplary project financing method.

FIG. 7 is a block diagram illustrating an exemplary project financing system.

### DETAILED DESCRIPTION

Some embodiments of the present invention are illustrated as an example and are not limited by the figures of the accompanying drawings, in which like references may indicate similar elements. The present invention will now be described by referencing the appended figures representing preferred embodiments.

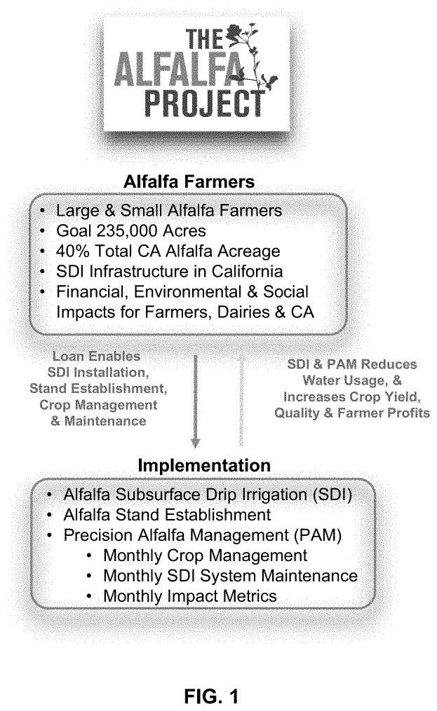

The present application discloses a method and system for financing projects. Certain large-scale projects that can potentially bring beneficial environmental, social, or economic impacts often need heavy capital investment at the initial stage before any tangible social or economic effects can be achieved. One example of such projects is California's Alfalfa agricultural project. FIG. 1 explains how the Alfalfa project have successfully reduced water consumption while at the same time boosting crop yield. In central California, alfalfa is widely planted and harvested as livestock feed. Because conventional alfalfa irrigation consumes a large amount of water, it is important to control and reduce the water usage of alfalfa crops. A technique called Precision Alfalfa Management (PAM) utilizes subsurface drip irrigation (SDI) methods to reduce water usage, increase crop yield and quality, and improve farmer profits. PAM techniques can be implemented by large and small alfalfa farmers but require significant capital investment. The goal of the Alfalfa project is to increase the total number of farms that use PAM techniques so that 40% of California's Alfalfa acreage will employ PAM techniques. This translates to over 235,000 acres of farm land. To implement this project, farmers need to install Alfalfa subsurface drip irrigation (SDI) system and also follow the PAM practice guidelines. The PAM guidelines require monthly crop management, monthly SDI system maintenance, and monthly impact metrics monitoring. It is a capital-intensive project. Although the project will undoubtedly bring economic benefits to farmers who choose to participate and bring environmental benefits to the general society, farmers need to take out initial loans to install SDI equipment and to carry out the required monitoring and maintenance activities.

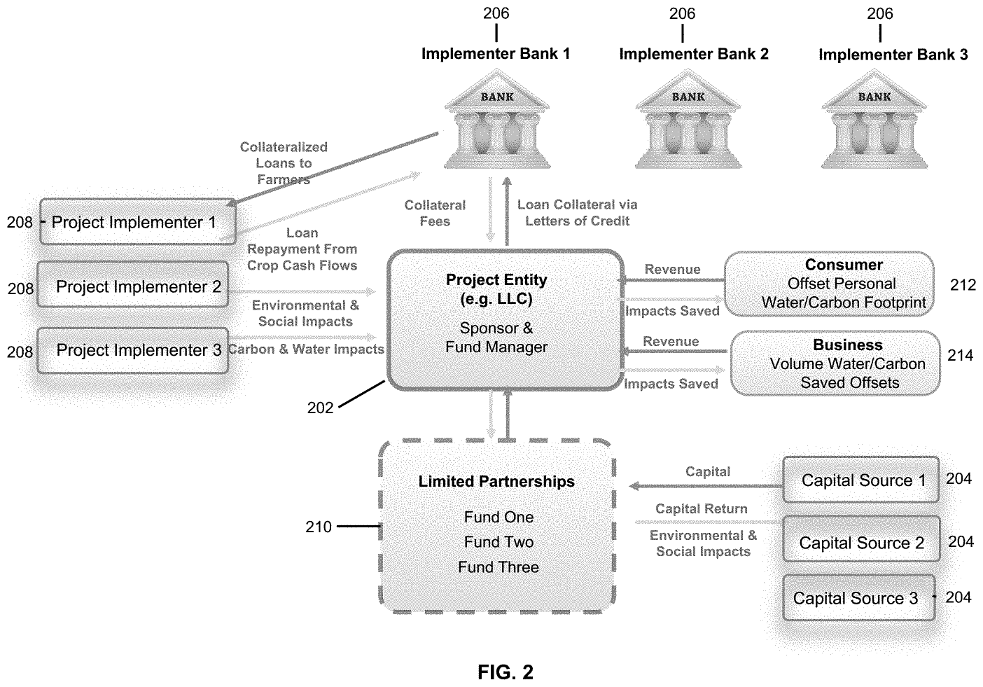

The present application discloses a novel method of financing a project like the Alfalfa project. As illustrated in FIG. 2, a project entity 202 is formed to facilitate the undertaking of financing and managing the project. The project entity 202 may also be known as the sponsor or fund manager of the project. In some embodiments, the project entity 202 may organize multiple funding initiatives throughout the project. For each funding initiative, a limited partnership 210, e.g., Fund One. Fund Two, and Fund Three, may be formed. The limited partnership 210 receives capital from different capital sources 204. The pooled capitals can come from diverse capital sources 204. For example, corporations, public or private foundations, government agencies, industry co-operations, non-profit organizations, or private individuals are potential sources that can contribute capital to the project. Once a fund is formed, the project entity 202 may manage the fund itself, or entrust a bank or a third-party wealth management firm to invest the pooled capital. The purpose for pooling the capitals from different sources is to implement the project and reduce the total risk associated to each source.

The pooled capitals enable the project implementers 208 to implement the project. Each implementer of the project 208 needs initial investment to buy and install equipment. In one embodiment, the initial investment may come in the form of a loan from an implementer bank 206. In some embodiments, implementer banks 206 are partnership banks designated by the project entity 202. Each implementer bank 206 receives a letter of credit from the project entity 202, which will be used as collateral for loans taken out by the project implementers 208. In return, the project entity 202 receives collateral fees from the project implementers 208 through the project banks 206.

After a project implementer 208 receives a loan from one of the implementer banks 206, the project implementer 208 uses the loan to buy farm equipment and employ other resources to implement the project. Over time, the proceeds from the crops can be used to repay the loan. Besides the cash flow generated from the crops, the project implementers 208 may receive compensation from the beneficial impacts achieved by the project. The beneficial impacts may be social, environmental, humanitarian or indirect economic benefits. For example, the beneficial impacts may be reduced water consumption or reduced greenhouse gas emission.

Under certain federal or state government policies or other monetizing markets, beneficial environmental or social impacts can be converted into credits or offsets. For example, water consumption reduction can be converted into water offsets. Carbon emission reduction can be converted into carbon credits or offsets.

In some embodiments, the project entity 202 may aggregate those credits or offsets and trade them on a market. Examples of such market include the compliance market, voluntary market or other markets. In one embodiment, water offsets can be sold to individual consumers 212 or businesses 214 as water neutrality certificates or wholesale transactions to offset water use in business operations. The revenue generated from the sales can be allocated to the pooled capital and/or distributed among the project implementers 208, e.g., on a pro rata basis.

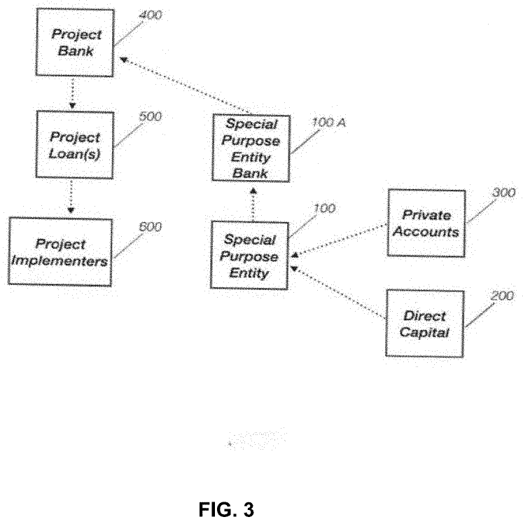

FIG. 3 is a block diagram illustrating the exemplary business method of pooling capital to finance a special project described above. In FIG. 3, a special purpose entity 100 is formed for the purpose of financing the project. In some embodiments, the special purpose entity 100 has no purpose other than financing the project and may cease to exist when the project is finished. In other embodiments, instead of the special purpose entity, a conventional entity 100 may be formed. The conventional entity 100 has other functions or objectives besides financing the project and may continue to exist after the project is finished. In some embodiments, the special purpose entity 100 is associated with one or more associated banks, referred to as the special purpose entity bank 100A in FIG. 3, to receive and coordinate capital from multiple and diverse sources, such as direct capital 200 and private accounts 300. In some embodiments, the direct capital 200 may come from corporations, foundations, government or non-profit grants. For example, certain government or non-profit grants provide program or mission related investments, in the form of, for example, a five-year loan. In some embodiments, the capital from the private accounts 300 may remain in the private accounts 300 but contribute towards the collateral. The associated bank 100A holds the pooled capital and utilizes the pooled capital as collateral to issue a letter of credit to the project bank 400. The project bank 400, is then able to issue collateral backed loans 500 to the project, enabling the project implementers 600 to implement the project. In some embodiments, the amount of the project loans 500 may be the same as the collateral. In a leveraged scenario, the collateral backed project loans 500 can be larger than the collateral. The special purpose entity bank 100A receives collateral fees from the project implementers 600 through the project bank 400 and uses the collateral fees to fund and support the special purpose entity 100. The special purpose entity bank 100A also invests the pooled capital and receives returns on the investment. The return on investment will be shared between the special purpose entity bank 100A and the capital sources, i.e., the private accounts 300 and the direct capital source 200, with the sharing percentages determined according to an agreement. The agreement may further specify a schedule in which the pooled capital shall be repaid to the capital sources. For example, the agreement may specify that the pooled capital, e.g., 10 million in total, shall be returned to the capital sources plus interest within 5 years. Table 1 illustrates an exemplary schedule of repaying the pooled capital to the capital sources. The special purpose entity 100 may cease to exist after the pooled capital is fully repaid.

TABLE 1

| Amount of capital | Year in operation |
|---|---|
| 10 million | 1^{st} year |
| 10 million | 2^{nd} |
| 8 million | 3^{rd} |
| 6 million | 4^{th} |
| 4 million | 5^{th} |

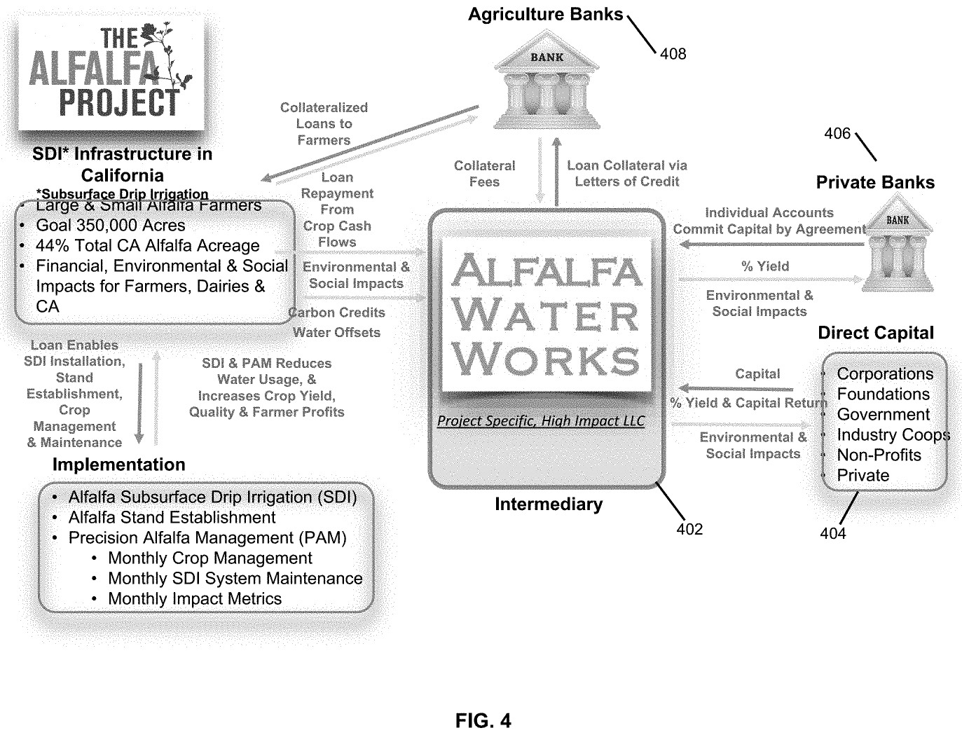

FIG. 4 is another illustration of the capital pooling method disclosed herein. In referring to FIG. 4, a special project entity 402, Alfalfa Water Works (AWW), is created to finance PAM. AWW 402 coordinates different types of direct capital sources 404 and pools the capital from those sources. The direct capital sources 404 may include corporations, foundations, government agencies, industry cooperation, non-profit organizations and private organizations. The direct capital sources 404 invest capital in AWW 402 and receive annual yields and capital returns. The return on investment may be monetary or non-monetary. For certain non-profit grants, the return can be in the form of environmental or social impacts achieved through the program. AWW 402 may also pool capital from individual accounts in private banks 406. The individual accounts commit capital through an agreement with AWW 402, and receive financial yields and/or credits of environmental or social impacts. Once the capital has been pooled together by AWW 402, AWW 402 utilizes one or more banks to manage the pooled capital and to issue letters of credit to project banks, for example, the agriculture banks 408 shown in FIG. 4. AWW 402 receives collateral fees from the agriculture banks 408 and uses them to offset operating costs. The collateral fees can also be used as incentive payments for the pooled capital. Against the collateral, the agriculture banks 408 issue collateralized loans to farmers. The loans enable the farmers to install subsurface drip irrigation (SDI) systems and to pay for PAM programs, which allow the farmers to reap economic benefits of reduced water usage, increased crop yields, and improved crop qualities. In some cases, the farmers assign or transfer to AWW the financial credits, e.g., carbon credits, generated from the environmental and social impacts of the programs as shown in FIG. 1.

In the embodiment illustrated in FIG. 4, a special purpose entity 402 is used to collect capital from multiple and diverse sources, 404 and 406, (capital pooling) into an entity that subsequently issues letters of credit to an agricultural bank 408 as collateral for a loan or loans used to finance a project. The sourcing of capital from multiple and diverse sources is a form of capital pooling for achieving a desired result. Instead of utilizing the pooled capitals directly to finance the project, the pooled capitals are held at the special purpose entity's bank (e.g., 100A in FIG. 3), and this bank issues a letter of credit backed by the pooled capitals as collateral to the project's bank (e.g., 400 in FIGS. 3 and 408 in FIG. 4) enabling loan(s) for the project.

In subsequent years of the project's loan, additional capitals in the form of the project's assets and principal payments on the outstanding loans reduce the amount of pooled collateral needed by the project's bank. The amount of pooled collateral can therefore be reduced each year when the project's loan is still outstanding. In this case a portion of the pooled capitals is released/returned to its sources, thereby reducing the risk to the collateral owners (capital sources) during the project's loan term.

In some embodiments, in the event of a default in any of the project's loan(s), the risk is spread pro-rata among all the pooled capital sources, thereby further reducing the risk exposure of any single capital source.

In some embodiments, securities backed up by the pooled capitals, such as financial instruments underlying the pooled capital that can be easily converted to cash within a year may be sold on the market. Any interest and/or dividends earned by the marketable securities may be split with an agreed upon percentage between the capital source and the special purpose entity. The share of the interest or dividends allocated to the special purpose entity 402 may be utilized as general operating expenses. In one embodiment, all other interest and/or dividends earned from the marketable securities are paid to the capital source.

In some embodiments, as part of the letter of credit issued to the project bank 408 from the special purpose entity 402, the special purpose entity 402 charges a collateral fee to the project bank 408, which may in turn be made as part of the project loans. In some embodiments, the collateral fee received by the special purpose entity 402 may be used to fund general operations of the special purpose entity 402.

In one embodiment, another example of pooling capitals is when individuals and/or entities commit capital to the special purpose entity by issuing a letter of credit from their existing bank to the special purpose entity 402. This allows the capital source to keep the funds in their existing accounts, and to continue to earn and retain any interest and/or dividends from those accounts. Other variations of this arrangement can also be included as capital sources.

The methods and systems taught in the present disclosure can be extended and is intended to cover all projects that utilize the systems and methods disclosed herein to achieve financial, environmental and social impacts. The feature of quantifying financial, environmental and social impacts in this business method is considered part of this method. As an example, if the financed project reduces carbon dioxide in the environment, and carbon dioxide is quantified and monetized as carbon credits, such credits can be used a revenue source for the special purpose entity 402 and used to fund general operations. As an incentive to maximize the impacts achieved by a project, an impact pool can be setup for the benefit of both the project and the capital sources.

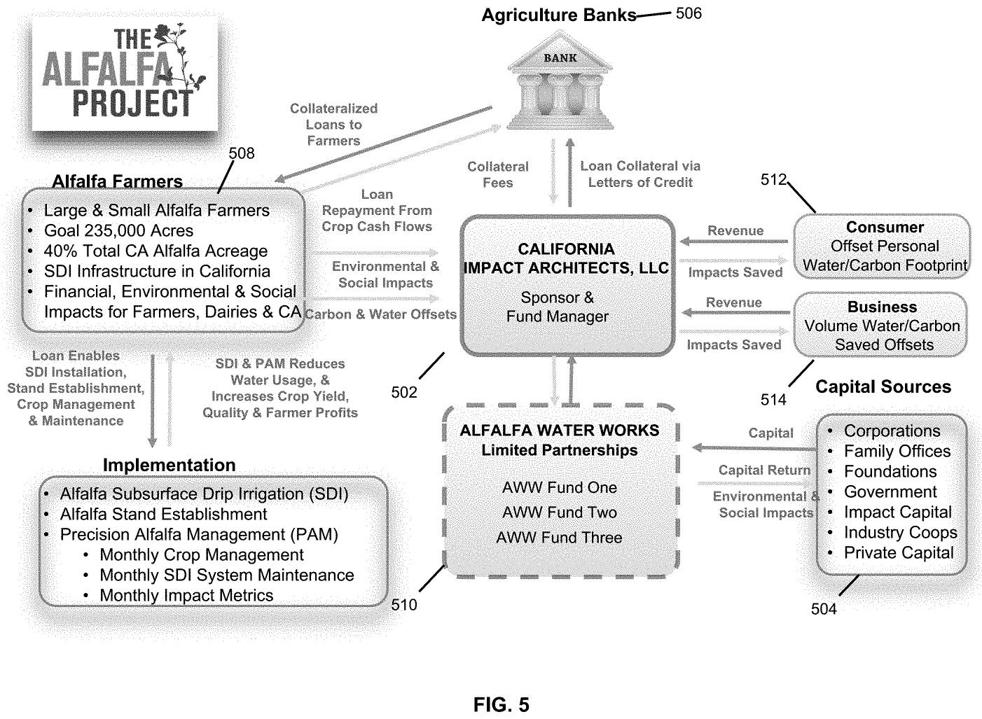

FIG. 5 illustrates yet another embodiment. This embodiment shows the use of a general partner 502 and limited partner entity 510 to replace the special purpose entity 402. In this embodiment the limited partner fund or funds 510 are managed by a general partner entity 502. The capital from multiple and diverse sources is received into the limited partner fund(s) 510. The limited partner 510 issues a letter of credit to the agricultural banks 506 as collateral for the loans lent to the alfalfa farmers. Revenue of the limited partnership comes from collateral fees from the agricultural banks 506, investment revenue on the capital while on deposit in the limited partnership's bank, and any carbon and/or water offsets derived from the alfalfa project. The limited partner funds 510 pay an operating fee to the general partner 502, and the general partner 502 receives a percentage of the net income of the limited partner fund(s) 510 over time. See FIG. 4 for differences between the embodiment in FIG. 5 and the embodiment in FIG. 4. This embodiment in FIG. 5 also provides fixed returns for the capital sources from the limited partners 510 and the general partner 512 that operate the limited partner funds. This embodiment also increases the collateral fees from the bank. In one embodiment, with the letter of credit as collateral, an additional change is that the general partner 502 may guarantee the agricultural bank loan to the farmer 508 in exchange for the right to operate, harvest and monetize the alfalfa field for the life of the loan in the event of a loan default by the farmer 508, thereby insuring the loan repayment.

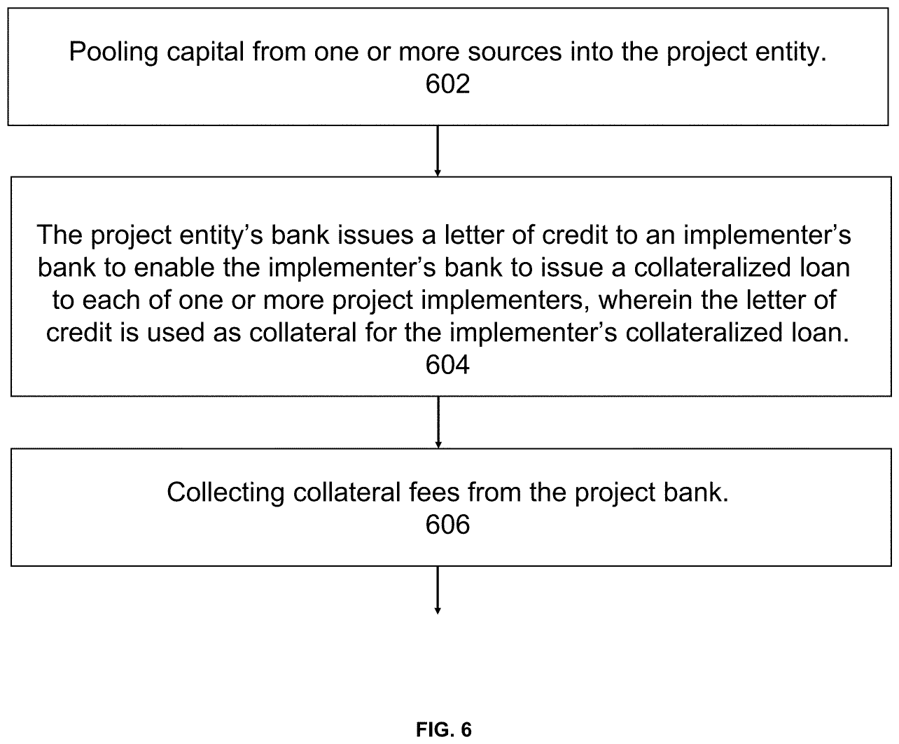

FIG. 6 illustrates a flow diagram of an exemplary method of pooling capital to finance a project. In the exemplary method, capitals from one or more sources, 200 and 300, are pooled into a project entity 100 (step 602). In some embodiments, the project entity employs a bank 100A. The project entity's bank 100A issues a letter of credit to an implementer's bank 400 to enable the implementer's bank 400 to issue a collateralized loan 500 to each project implementer 600, wherein the letter of credit is used as collateral for the implementer's collateralized loan 500 (step 604). In return for providing the pooled capitals as collateral, the project entity 100 collects collateral fees from the project bank 100A (step 606).

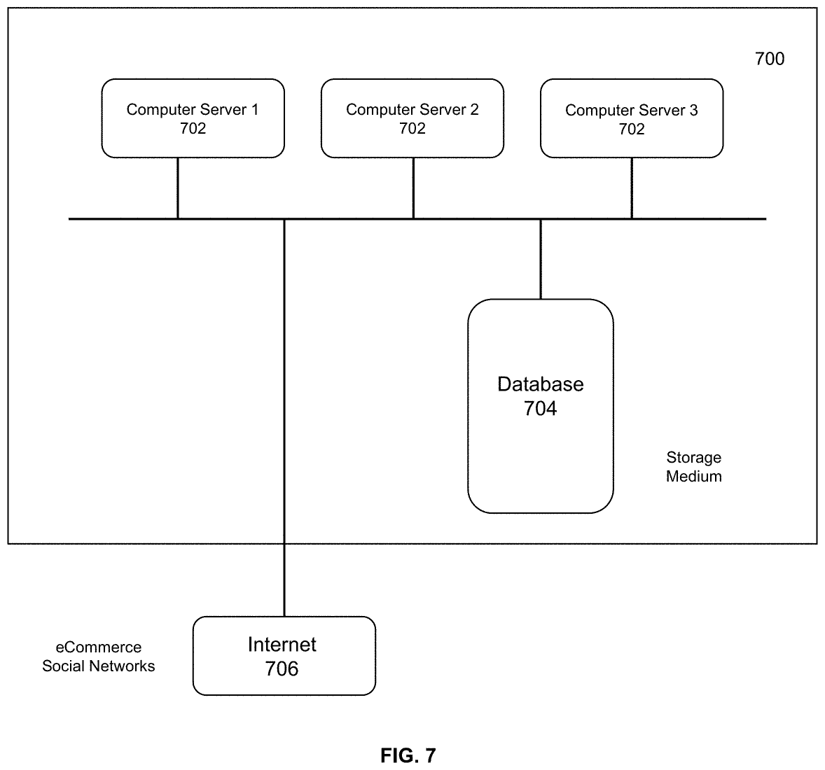

FIG. 7 illustrates an exemplary system 700 configured to implement a project financing method described herein. The system 700 comprises one or more computer servers 702 and a storage medium 704. The system 700 is connected to the Internet 706. The one or more computer servers 702 are configured to process data, e.g., financial and organizational data, related to the project. The storage medium 704 is configured to store the data related to the project. In some embodiments, the computer servers 702 are configured to generate a record of contributed capitals from one or more capital sources, 200 and 300, when the one or more capital sources, 200 and 300, join the project. The computer servers 702 are further configured to issue a letter of credit to a project bank 400, based on the record of contributed capital. The letter of credit is used as collateral and enables the project bank 400 to lend a collateralized loan 500 to a project implementer 600.

Although the disclosure is illustrated and described herein with reference to specific embodiments, the disclosure is not intended to be limited to the details shown. Rather, various modifications may be made within the scope and range of equivalents of the claims and without departing from the disclosure.

What is claimed is:

1. A system for organizing and managing a project using a project entity, said system comprising:
one or more computer servers for processing data related to the project; and
a storage medium for storing the data related to the project;
wherein the one or more computer servers are configured to:
generate a record of pooled capital from one or more capital sources when the one or more capital sources join the project;
track issued letters of credit based on the pooled capital to enable a project bank to lend a collateralized loan to each of one or more project implementers, wherein the issued letters of credit are used as collateral for the collateralized loan;
receiving information of social or environmental impacts achieved by the one or more project implementers; and
converting the information of social or environmental impacts into credits.

2. The system of claim 1, further comprising:
collecting collateral fees based on the issued letters of credit.

3. The system of claim 1, wherein the information of social or environmental impacts is a quantified amount of carbon dioxide emission reduction and the converted credits are carbon credits.

4. The system of claim 1, wherein the information of social or environmental impact is a quantified amount of water consumption reduction and the converted credits are water offsets.

5. The system of claim 3, wherein the carbon credits are traded in a compliance, voluntary or other market.

6. The system of claim 4, wherein the water offsets are traded in a compliance, voluntary or other market.

7. The system of claim 1, further comprising trading the converted credits in a compliance, voluntary or other market, wherein revenues generated from the trading of the credits are allocated to the one or more project implementers.

8. The system of claim 7, wherein the revenues are allocated to the one or more project implementers on a pro rata basis according to the social or environmental impacts achieved by each of the one or more project implementers.

9. A method of financing a project through a project entity, comprising:
pooling capital from one or more sources into the project entity;
issuing a letter of credit to a project bank to enable the project bank to issue a collateralized loan to one or more project implementers, wherein the letter of credit is used as collateral for the collateralized loan; and
collecting collateral fees from the project bank.

10. The method of claim 9, further comprising:
quantify a social or environmental beneficial impact achieved by the one or more project implementers; and
converting the quantified beneficial impact into revenue.

11. The method of claim 10, wherein the quantified beneficial impact is an amount of greenhouse gas emission reduction in the form of carbon credits.

12. The method of claim 10, wherein the quantified beneficial impact is an amount of water consumption reduction in the form of water offsets.

13. The method of claim 10, wherein the converting of the quantified beneficial impact into revenue comprises trading the quantified beneficial impact as credits or offsets.

14. The method of claim 10, wherein the one or more sources comprise corporations, foundations, government agencies, industry co-operatives, non-profit organizations, private individuals or other sources.

15. The method of claim 10, further comprising:
investing the pooled capital to generate investment returns.

16. A non-transitory computer-readable medium storing a computer software program, wherein, said computer software program, when executed by a computer processor, causes the computer processor to:
generate a record of contributed capital from one or more capital sources when the one or more capital sources join a project;
issue an order for a letter of credit to the project bank based on the record of contributed capital to enable a project bank to issue a collateralized loan to one or more project implementers, wherein the letter of credit is used as collateral for the collateralized loan;
receiving information of social or environmental impacts achieved by the one or more project implementers;
converting the information of social or environmental impacts into credits or offsets; and
trading the credits or offsets to generate revenue.
